(19) United States
(12) Patent Application Publication
(10) Pub. No.: US 2014/0254016 A1
(43) Pub. Date: Sep. 11, 2014

(54) OPTICAL ELEMENT, METHOD FOR MANUFACTURING OPTICAL ELEMENT, AND PROJECTOR

(71) Applicant: SEIKO EPSON CORPORATION, Tokyo (JP)

(72) Inventor: Akira EGAWA, Shiojiri-shi (JP)

(73) Assignee: SEIKO EPSON CORPORATION, Tokyo (JP)

(21) Appl. No.: 14/190,588

(22) Filed: Feb. 26, 2014

(30) Foreign Application Priority Data
Mar. 7, 2013 (JP) 2013-045719
Dec. 5, 2013 (JP) 2013-252326

(51) Int. Cl. G02B 27/00; G02B 5/18

(52) U.S. Cl. CPC G02B 27/0006; G02B 5/18
USPC 359/513; 359/558; 264/1.7

(57) ABSTRACT

An optical element includes: a first glass substrate; a second glass substrate; a diffractive element disposed on the first glass substrate and made of a resin; a spacer disposed between the first glass substrate and the second glass substrate and regulating a gap between the first glass substrate and the second glass substrate; and a void disposed between the second glass substrate and the diffractive element.

### BACKGROUND

1. Technical Field

The present invention relates to an optical element, a method for manufacturing the optical element, and a projector.

2. Related Art

Heretofore, it has been proposed to use a diffractive optical element in a projector using a laser light source, as shown in JP-A-2007-286110.

In such a configuration, however, when dust or dirt adheres to the diffractive optical element, the dust or dirt adsorbs a laser beam and generates heat. Therefore, when the diffractive optical element is irradiated with a high-intensity laser beam, the temperature of the diffractive optical element becomes high due to the heat generation by the dust or dirt, leading to a risk of breakage of the diffractive optical element.

### SUMMARY

An advantage of some aspects of the invention is to provide an optical element capable of suppressing the breakage of a diffractive optical element and therefore excellent in reliability, and a method for manufacturing the optical element. Another advantage of some aspects of the invention is to provide, with the use of the optical element, a projector excellent in reliability.

An optical element according to an aspect of the invention includes: a first glass substrate; a second glass substrate; a diffractive element disposed on the first glass substrate and made of a resin; a spacer disposed between the first glass substrate and the second glass substrate and regulating a gap between the first glass substrate and the second glass substrate; and a first void disposed between the second glass substrate and the diffractive element.

According to the configuration, the diffractive element is interposed between the first glass substrate and the second glass substrate. Therefore, it is possible to suppress the adhesion of dust or dirt to a surface of the diffractive element. Moreover, since the first void is included, even when the second glass substrate generates heat, the heat generated in the second glass substrate is less likely to be conducted to the diffractive element. Hence, the optical element excellent in reliability is obtained in which even when the intensity of a laser beam is high, it is possible to suppress a degradation of the diffractive element due to the heat generation by the dust or dirt.

The first void may be hermetically sealed.

According to the configuration, since the first void disposed between the second glass substrate and the diffractive element is hermetically sealed, dust or dirt does not enter the interior of the first void from a gap between the first glass substrate and the second glass substrate in a side surface of the optical element. With this configuration, dust or dirt does not adhere to the surface of the diffractive element. Therefore, according to the configuration, the reliability of the optical element can be further improved.

A communication hole may be formed in the spacer such that the first void communicates with an outer space.

According to the configuration, since the first void and the outer space are in communication with each other through the communication hole, the first void is not hermetically sealed. With this configuration, even when a gas in the first void thermally expands, the damage of the optical element can be suppressed.

The spacer and the diffractive element may be integrated with each other.

According to the configuration, it is possible to adopt a manufacturing method in which the spacer and the diffractive element are simultaneously formed.

A second void may be disposed between the spacer and the diffractive element.

In a case where dust or dirt adheres to the second glass substrate, the dust or dirt generates heat upon irradiation of a laser beam, so that the temperature of the second glass substrate becomes high. In this case, the heat of the second glass substrate is conducted to the first glass substrate or the diffractive element via the spacer. In this configuration, however, since the second void is present between the spacer and the diffractive element, it is possible to suppress the conduction of heat of the second glass substrate to the diffractive element via the spacer. With this configuration, it is possible to suppress a degradation of the diffractive element, so that the optical element excellent in reliability is obtained.

A method for manufacturing an optical element according to another aspect of the invention includes: applying a resin on a first glass substrate to form a resin layer; pressing a mold against the resin layer to pattern the resin layer, thereby forming a diffractive element and a spacer having a thickness larger than that of the diffractive element; curing the resin layer; and placing a second glass substrate on the spacer.

According to the manufacturing method, after applying a resin on the first glass substrate to form the resin layer, the resin layer is patterned into the shapes of the diffractive element and the spacer by pressing the mold. That is, since the diffractive element and the spacer are simultaneously formed, the spacer is formed with accuracy equal to that of the diffractive element. Hence, when the patterned resin layer is baked and the second glass substrate is placed on the spacer, it is possible to suppress the contact of the second glass substrate with the diffractive element or the oblique placement of the second glass substrate.

After patterning the resin layer, the second glass substrate may be placed on the spacer that is uncured, and then, the resin layer may be cured.

According to the manufacturing method, the second glass substrate is placed on the uncured spacer, and then, the uncured spacer and the uncured diffractive element that are formed by patterning the resin layer are baked. With this configuration, the uncured spacer is cured to fix the second glass substrate to the spacer. Hence, since the labor of separately bonding the second glass substrate to the spacer is saved, the method is simple.

In the forming of the spacer, a cut-out portion may be formed in the spacer, and the cut-out portion may constitute a communication hole that makes a first void disposed between the second glass substrate and the diffractive element communicate with an outer space.

According to the manufacturing method of the configuration, since the communication hole that makes the first void communicate with the outer space is formed, even when a gas in the first void thermally expands, the damage of the optical element can be suppressed.

A projector according to still another aspect of the invention includes the optical element according to the aspect of the invention.

According to the configuration, the optical element that is less likely to be broken even when being irradiated with a high-intensity laser beam is included, so that the projector excellent in reliability is obtained.

The projector may further include: a solid-state light source irradiating the optical element with light; and a light modulator modulating light emitted from the optical element, wherein the light from the solid-state light source may be incident on the diffractive element from the second glass substrate side.

According to the configuration, the light emitted from the light source is incident on the diffractive element via the second glass substrate and the first void between the second glass substrate and the diffractive element. Then, light diffused by the diffractive element passes through the first glass substrate to be emitted to the outside. Since the light incident on the second glass substrate is light emitted from the solid-state light source such as a laser light source, the intensity of the light is high. Therefore, in a case where dust or dirt adheres to a light incident surface of the second glass substrate, the dust or dirt generates heat, so that the temperature of the second glass substrate is likely to become high. Therefore, in the configuration, light is incident from the side where the first void is disposed between the second glass substrate and the diffractive element. With this configuration, the heat of the second glass substrate is less likely to be conducted to the diffractive element.

Moreover, since the light emitted from the first glass substrate is diffused by the diffractive element, the intensity of the light emitted from the first glass substrate is low. Therefore, even when dust or dirt adheres to a light emitting surface of the first glass substrate, the amount of heat generated due to the irradiation of the dust or dirt with light is small, and the possibility of a degradation of the diffractive element is low.

### BRIEF DESCRIPTION OF THE DRAWINGS

The invention will be described with reference to the accompanying drawings, wherein like numbers reference like elements.

FIGS. 1A and 1B show an optical element of a first embodiment, in which FIG. 1A is a plan view; and FIG. 1B is a cross-sectional view taken along line A-A in FIG. 1A.

FIGS. 2A to 3E are cross-sectional views showing a method for manufacturing the optical element of the first embodiment.

FIGS. 3A to 3E are cross-sectional views showing a method for manufacturing the optical element of a second embodiment.

FIG. 4 is a cross-sectional view showing an optical element of a third embodiment.

FIGS. 5A to 5E are cross-sectional views showing a method for manufacturing the optical element of the third embodiment.

FIGS. 6A and 6B show an optical element of a fourth embodiment, in which FIG. 6A is a plan view; and FIG. 6B is a cross-sectional view taken along line B-B in FIG. 6A.

FIG. 7 is a perspective view showing the optical element of the fourth embodiment.

FIG. 8 is a schematic view showing a projector using the optical element of the first embodiment.

FIG. 9 is an explanatory view explaining the projector using the optical element of the first embodiment.

### DESCRIPTION OF EXEMPLARY EMBODIMENTS

Hereinafter, an optical element, a method for manufacturing the optical element, and a projector according to embodiments of the invention will be described with reference to the drawings.

The scope of the invention is not limited to the embodiments described below, and any modifications can be made within the scope of the technical idea of the invention. In the drawings described below, the scale, number, or the like in each structure is different, in some cases, from the actual structure for facilitating the understanding of each configuration.

### First Embodiment

### Optical Element

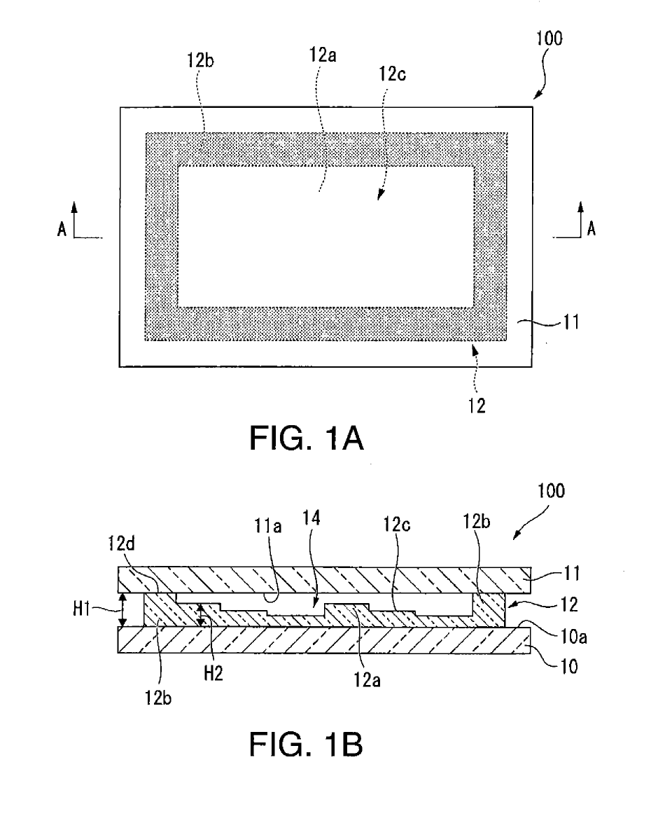

FIGS. 1A and 1B show an optical element of a first embodiment, in which FIG. 1A is a plan view; and FIG. 1B is a cross-sectional view taken along line A-A in FIG. 1A.

As shown in FIGS. 1A and 1B, the optical element 100 of the embodiment includes a base (first glass substrate) 10, a diffractive member 12, and a cover glass (second glass substrate) 11.

The base 10 is a glass substrate. The plan-view shape of the base 10 may be rectangular or other shapes (for example, circular, and rectangular in FIG. 1A). The size of the base 10 is not particularly limited. For example, when the plan-view shape is rectangular, the length of one side may be from 20 to 80 mm.

The diffractive member 12 is formed on a top surface 10a of the base 10. The diffractive member 12 includes a diffractive element portion (diffractive element) 12a and a spacer portion (spacer) 12b. The plan-view shape of the diffractive member 12 may be rectangular or other shapes (for example, circular, and rectangular in FIG. 1A). The material of the diffractive member 12 is a transparent thermosetting resin.

The diffractive element portion 12a is a computer-generated hologram (hereinafter referred to as CGH) obtained by forming a concave-convex structure designed by a computer. The CGH is a wavefront converting element for converting the wavefront of incident light using a diffraction phenomenon. Especially a phase modulating CGH can execute the wavefront conversion with little energy loss of the incident light wave. As described above, the CGH can generate a uniform intensity distribution or an intensity distribution with a simple form.

Specifically, the diffractive element portion 12a has a stepped shape in a plane thereof for obtaining a desired diffraction interference effect. On a surface 12c of the diffractive element portion 12a, a plurality of concave-convex portions different in height is formed. The plurality of concave-convex portions is arrayed in a planar manner such that the pitch and height of the concave-convex portions satisfy a predetermined surface condition, and are configured so as to provide a predetermined diffusing function. The step height of the concave-convex portion on the surface 12c of the diffractive element portion 12a is, for example, from 50 to 200 nm. The thickness (distance between the top surface 10a of the base 10 and the surface 12c of the diffractive element portion 12a) of the diffractive element portion 12a is, for example, from 1 to 10 μm.

The spacer portion 12b has a frame shape surrounding the diffractive element portion 12a in a plan view. In the case of the embodiment, the spacer portion 12b is formed integrally with the diffractive element portion 12a along the circumferential edge of the diffractive element portion 12a. As shown in FIG. 1B, a thickness H1 of the spacer portion 12b is larger than a thickness H2 (maximum thickness of the diffractive element portion 12a) of the diffractive element portion 12a. The thickness H1 of the spacer portion 12b is set in accordance with the thickness H2 of the diffractive element portion 12a, and is, for example, from 5 to 200 μm.

The cover glass 11 is a glass substrate. The cover glass 11 is bonded to a top surface 12d of the spacer portion 12b of the diffractive member 12. The cover glass 11 interposes the diffractive member 12 with the base 10. The plan-view shape and size of the cover glass 11 are substantially the same as the plan-view shape and size of the base 10. The cover glass 11 and the base 10 are arranged so as to substantially overlap with each other in a plan view.

As described above, the thickness H1 of the spacer portion 12b is larger than the thickness H2 of the diffractive element portion 12a. Therefore, a gap between the base 10 and the cover glass 11 is regulated by the spacer portion 12b, and a void (first void) 14 is formed between a back surface 11a of the cover glass 11 and the surface 12c of the diffractive element portion 12a.

The void 14 is a space surrounded and hermetically sealed by the spacer portion 12b, the diffractive element portion 12a, and the cover glass 11. In the case of the embodiment, the interior of the void 14 is filled with an inert gas. The inert gas is not particularly limited, and is, for example, nitrogen. A vacuum may be established in the void 14.

### Method for Manufacturing Optical Element

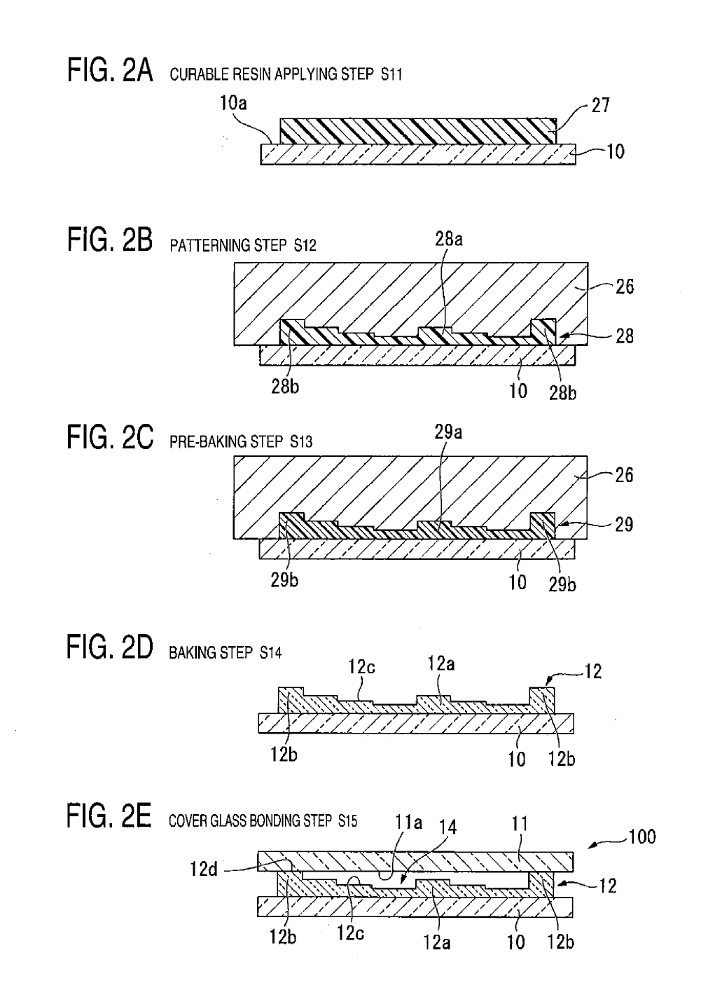

FIGS. 2A to 2E are cross-sectional views showing a method for manufacturing the optical element 100 of the embodiment.

As shown in FIGS. 2A to 2E, the method for manufacturing the optical element 100 of the embodiment includes a curable resin applying step S11, a patterning step S12, a pre-baking step S13, a baking step S14, and a cover glass bonding step S15.

As shown in FIG. 2A, the curable resin applying step S11 is a step of applying an uncured thermosetting resin to the top surface 10a of the base 10.

The thermosetting resin is not particularly limited as long as the thermosetting resin is transparent for light in a wavelength range to be used.

By applying the thermosetting resin, a resin layer 27 is formed on the top surface 10a of the base 10. The applying method is not particularly limited, and for example, a droplet discharge method such as an ink-jet method, a spin coating method, a slit coating method, or the like can be used.

Next, as shown in FIG. 2B, the patterning step S12 is a step of patterning the resin layer 27 using a mold 26.

The mold 26 is a master mold in which the concave-convex shape obtained by inverting the shape of the surface 12c of the diffractive element portion 12a and the shape of the spacer portion 12b shown in FIG. 2D are formed on a processing surface. On the processing surface of the mold 26, a release agent is applied for purposes of the prevention of adhesion of an uncured resin and an improvement in the releasability of the mold 26 from the base 10.

As shown in FIG. 2B, by pressing the mold 26 against the resin layer 27, the shapes of the diffractive element portion 12a and the spacer portion 12b are transferred to the surface of the resin layer 27. The pressing method is not particularly limited, and for example, a direct pressing method, a roller transfer method, a roll-to-roll method, or the like can be selected. Through this step, the resin layer 27 is subjected to stamping processing, so that an uncured diffractive member 28 (diffractive member made of an uncured resin material) is formed. The uncured diffractive member 28 is formed with an uncured diffractive element portion (diffractive element) 28a and an uncured spacer portion (spacer) 28b. On a surface of the uncured diffractive element portion 28a, a plurality of concave-convex portions different in height is arrayed in a planar manner. The uncured spacer portion 28b has a frame shape in a plan view and surrounds the circumference of the uncured diffractive element portion 28a.

Next, as shown in FIG. 2C, the pre-baking step S13 is a step of pre-baking the uncured diffractive member 28.

The pre-baking is performed in a state where the mold 26 is pressed against the uncured diffractive member 28. Through this step, the uncured diffractive member 28 is brought into a pre-baked state (a diffractive member 29 in the pre-baked state) in which a solvent is removed from the uncured diffractive member 28.

Next, as shown in FIG. 2D, the baking step S14 is a step of baking (final baking) the diffractive member 29 in the pre-baked state to form the diffractive member 12.

The mold 26 is removed, and the diffractive member 29 in the pre-baked state is baked. Through this step, the diffractive member 29 in the pre-baked state is cured to form the diffractive member 12. Moreover, a diffractive element portion 29a in the pre-baked state and a spacer portion 29b in the pre-baked state are cured to thereby form the diffractive element portion (diffractive element) 12a and the spacer portion (spacer) 12b.

Next, as shown in FIG. 2E, the cover glass bonding step S15 is a step of bonding the back surface 11a of the cover glass 11 to the top surface 12d of the spacer portion 12b.

The cover glass bonding step S15 is performed under an inert gas atmosphere. The inert gas is not particularly limited, and for example, nitrogen can be used.

The bonding method of the cover glass 11 is not particularly limited as long as the cover glass 11 and the spacer portion 12b can be fixed together. For example, a bonding method using surface-activated bonding, a bonding method using the tackiness of a resin as the material of the spacer portion 12b, or the like can be selected.

Through the step described above, the void 14 surrounded and hermetically sealed by the diffractive element portion 12a, the spacer portion 12b, and the cover glass 11 and filled with an inert gas is formed between the back surface 11a of the cover glass 11 and the surface 12c of the diffractive element portion 12a.

Through the steps described above, it is possible to manufacture the optical element 100 in which the diffractive element portion 12a is surrounded and sealed by the base 10, the cover glass 11, and the spacer portion 12b.

According to the optical element 100 of the embodiment described in detail above, the diffractive element portion 12a is surrounded and sealed by the base 10, the cover glass 11, and the spacer portion 12b. With this configuration, dust or dirt does not directly adhere to the diffractive element portion 12a. Hence, the heat generated due to the dust or dirt being irradiated with a laser beam is not directly conducted to the diffractive element portion 12a. Therefore, even when the intensity of the laser beam with which the diffractive element portion 12a is irradiated is high, the breakage of the diffractive element portion 12a due to heat can be suppressed. Therefore, according to the embodiment, the optical element excellent in reliability is obtained.

If an active gas is present around the diffractive element portion 12a, when the diffractive element portion 12a generates heat by being irradiated with a laser beam, the active gas reacts with the surface of the diffractive element portion 12a to change the quality of the diffractive element portion 12a. In contrast, according to the optical element 100 of the embodiment, the interior of the void 14 is filled with an inert gas. Therefore, even when the diffractive element portion 12a generates heat by being irradiated with a laser beam, it is possible to suppress the reaction of the diffractive element portion 12a with a gas component in the void 14. Hence, the quality of the diffractive element portion 12a is less likely to change even when the diffractive element portion 12a generates heat by being irradiated with a laser beam, so that the optical element excellent in reliability is obtained.

Moreover, rise in temperature of the diffractive element portion 12a can be suppressed. Therefore, even when a resin is used as the material of the diffractive element portion 12a, a degradation of the diffractive element portion 12a can be suppressed. It is inexpensive and easy to manufacture the diffractive element portion 12a using a resin compared to using glass or the like. Hence, the optical element excellent in reliability is easily obtained at low cost.

Moreover, dust or dirt does not directly adhere to the diffractive element portion 12a. Therefore, it is not necessary to, for example, directly wipe the surface of the diffractive element portion 12a, so that the cleaning or maintenance of the optical element is easy.

Moreover, according to the method for manufacturing the optical element 100 of the embodiment, the resin layer 27 is formed on the top surface 10a of the base 10, and then, the shapes of the diffractive element portion 12a and the spacer portion 12b are transferred to the resin layer 27 using the mold 26. In this case, very high-precision patterning with a step of about 100 nm is required for the patterning of the shape of the diffractive element portion 12a. Therefore, with the use of the mold 26 in which the concave-convex shape obtained by inverting the shape of the spacer portion 12b is formed with accuracy similar to the above accuracy, variations in the thickness H1 of the spacer portion 12b are suppressed, so that the flatness of the top surface 12d of the spacer portion 12b can be ensured. Hence, when the cover glass 11 is bonded to the top surface 12d of the spacer portion 12b, the top surface 12d of the spacer portion 12b and the cover glass 11 are uniformly bonded together and reliably sealed.

Moreover, since the labor of forming the spacer portion 12b separately from the diffractive element portion 12a is saved, the method is simple.

In the embodiment, the following configurations can also be adopted.

In the curable resin applying step S11, a photo-curable resin may be used. In this case, by irradiating the diffractive member 29 in the pre-baked state with light in the baking step S14, the diffractive member 29 in the pre-baked state is cured.

The material of the diffractive element portion 12a may be glass.

### Second Embodiment

A method for manufacturing the optical element of a second embodiment differs from the first embodiment in that before the baking step S14, the cover glass 11 is placed on the uncured spacer portion 29b. The same constituents as those of the first embodiment are appropriately denoted by the same reference numerals and signs as those of the first embodiment, and the description thereof is simplified or omitted.

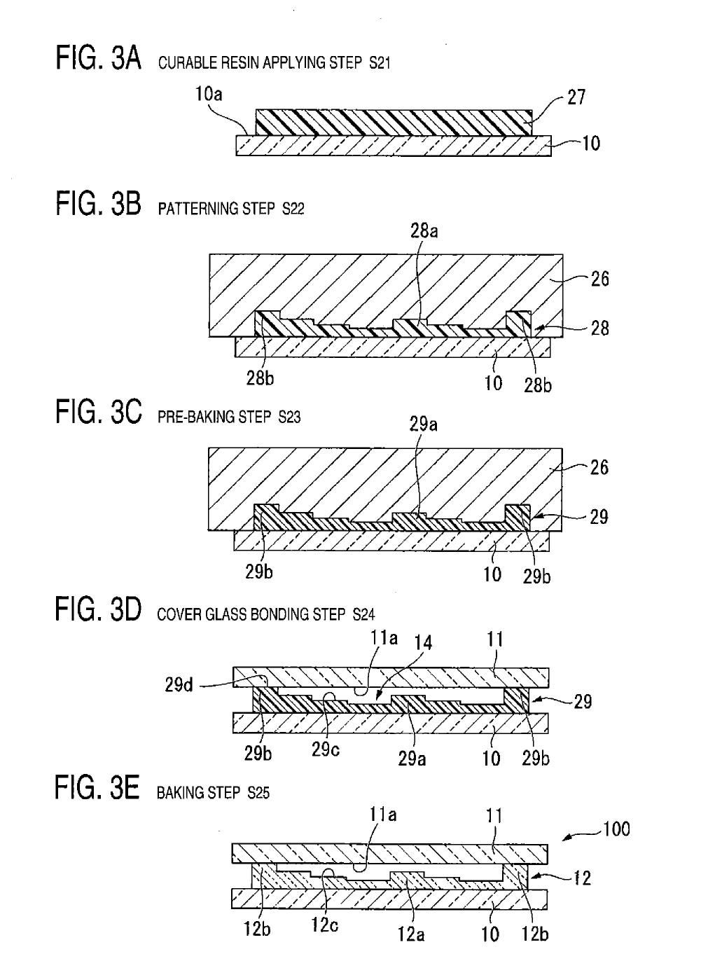

FIGS. 3A to 3E are cross-sectional views showing the method for manufacturing the optical element 100 of the embodiment.

The method for manufacturing the optical element 100 of the embodiment includes a curable resin applying step S21, a patterning step S22, a pre-baking step S23, a cover glass placing step S24, and a baking step S25.

As shown in FIG. 3A, the curable resin applying step S21 is the same as the curable resin applying step S11 of the first embodiment. Through this step, the resin layer 27 is formed.

Next, as shown in FIG. 3B, the patterning step S22 is the same as the patterning step S12 of the first embodiment. Through this step, the uncured diffractive member 28 is formed.

Next, as shown in FIG. 3C, the pre-baking step S23 is the same as the pre-baking step S13 of the first embodiment. Through this step, the uncured diffractive member 28 is brought into the pre-baked state (the diffractive member 29 in the pre-baked state) in which a solvent is removed from the uncured diffractive member 28.

Next, as shown in FIG. 3D, the cover glass placing step S24 is a step of placing the cover glass 11 on a top surface 29d of the spacer portion 29b in the pre-baked state.

The cover glass placing step S24 is performed under an inert gas atmosphere. The inert gas is not particularly limited, and for example, nitrogen can be used.

The cover glass 11 is placed such that the back surface 11a of the cover glass 11 abuts on the top surface 29d of the spacer portion 29b in the pre-baked state. The spacer portion 29b in the pre-baked state has some degree of hardness. Therefore, even when the cover glass 11 is placed by pressing against the spacer portion 29b with some degree of stress, the spacer portion 29b is not crashed, and the void 14 is formed between the back surface 11a of the cover glass 11 placed and a surface 29c of the diffractive element portion 29a in the pre-baked state. The void 14 is surrounded by the diffractive element portion 29a in the pre-baked state, the spacer portion 29b in the pre-baked state, and the cover glass 11. The inert gas of the atmosphere when bonding the cover glass 11 and the spacer portion 29b in the pre-baked state together is enclosed in the void 14.

Next, as shown in FIG. 3E, the baking step S25 is a step of baking the diffractive member 29 in the pre-baked state.

The diffractive member 29 in the pre-baked state is baked and cured. Through this step, the diffractive member 12 is formed. Moreover, the diffractive element portion 29a in the pre-baked state and the spacer portion 29b in the pre-baked state are cured to thereby form the diffractive element portion 12a and the spacer portion 12b.

Before the baking step S25, the spacer portion 29b (thermosetting resin) in the pre-baked state has some degree of adhesion. Therefore, due to the adhesion of the spacer portion 29b in the pre-baked state, the back surface 11a of the cover glass 11 and the top surface 29d of the spacer portion 29b in the pre-baked state adhere to each other. Then, in the process of baking the spacer portion 29b in the pre-baked state to cure the spacer portion 29b into the spacer portion 12b through the baking step S25, the cover glass 11 is fixed to the spacer portion 12b.

Through the steps described above, it is possible to manufacture the optical element 100 in which the diffractive element portion 12a is surrounded and sealed by the base 10, the cover glass 11, and the spacer portion 12b.

According to the method for manufacturing the optical element 100 of the embodiment, the cover glass 11 is fixed to the spacer portion 12b together with the curing of the diffractive member 29 in the pre-baked state in the baking step S25. Therefore, since it is not necessary in the cover glass placing step S24 to bond the cover glass 11 using an adhesive or the like, the method is simple.

### Third Embodiment

### Optical Element

An optical element of a third embodiment differs from the first embodiment in that a box-shaped cover glass including a portion corresponding to the spacer portion 12b is used instead of the cover glass 11. The same constituents as those of the first embodiment are appropriately denoted by the same reference numerals and signs as those of the first embodiment, and the description thereof is simplified or omitted.

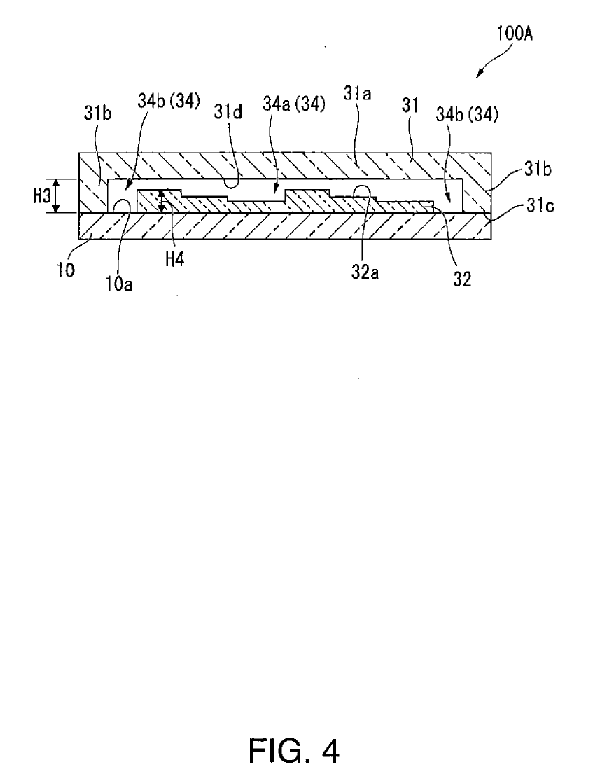

FIG. 4 is a cross-sectional view showing the optical element 100A of the embodiment.

As shown in FIG. 4, the optical element 100A of the embodiment includes the base 10, a cover glass 31, and a diffractive element 32.

The diffractive element 32 is formed on the top surface 10a of the base 10.

The diffractive element 32 is a diffractive optical element (CGH) having a stepped shape in a plane thereof. On a surface 32a of the diffractive element 32, a plurality of concave-convex portions different in height is formed. The plurality of concave-convex portions is arrayed in a planar manner such that the pitch and height of the concave-convex portions satisfy a predetermined surface condition, and are configured so as to provide a predetermined diffusing function. The step height of the concave-convex portion on the surface 32a of the diffractive element 32 is, for example, from 50 to 200 nm. A thickness H4 of the diffractive element 32 is, for example, from 1 to 10 μm.

The cover glass 31 includes a cover portion 31a and a spacer portion 31b.

The cover portion 31a is flat plate-shaped and has substantially the same shape and size as those of the base 10 in a plan view.

The spacer portion 31b has a frame shape in a plan view and is formed integrally with the cover portion 31a along the circumferential edge of the cover portion 31a. A back surface 31c of the spacer portion 31b is bonded to the top surface 10a of the base 10.

As the material of the cover glass 31, glass, quartz, or the like can be selected.

A thickness H3 of the spacer portion 31b is larger than the thickness H4 (maximum thickness of the diffractive element 32) of the diffractive element 32. The thickness H3 of the spacer portion 31b is set in accordance with the thickness H4 of the diffractive element 32, and is, for example, from 5 to 200 μm.

As described above, the thickness H3 of the spacer portion 31b is larger than the thickness H4 of the diffractive element 32. Therefore, a gap between the base 10 and the cover portion 31a is regulated by the spacer portion 31b, and a void 34 is formed between the base 10 and the cover glass 31. The void 34 is surrounded by the base 10, the cover glass 31, and the diffractive element 32.

The void 34 includes a first void portion (first void) 34a and a second void portion (second void) 34b. The first void portion 34a is disposed between the surface 32a of the diffractive element 32 and a back surface 31d of the cover portion 31a of the cover glass 31. The second void portion 34b is disposed between the spacer portion 31b of the cover glass 31 and the diffractive element 32.

In the case of the embodiment, the interior of the void 34 is filled with an inert gas. The inert gas is not particularly limited, and is, for example, nitrogen. A vacuum may be established in the void 34.

### Method for Manufacturing Optical Element

A method for manufacturing the optical element 100A of the embodiment differs from the first embodiment in that the cover glass 31 serving as both the spacer portion 12b and the cover glass 11 is bonded in the cover glass bonding step S15.

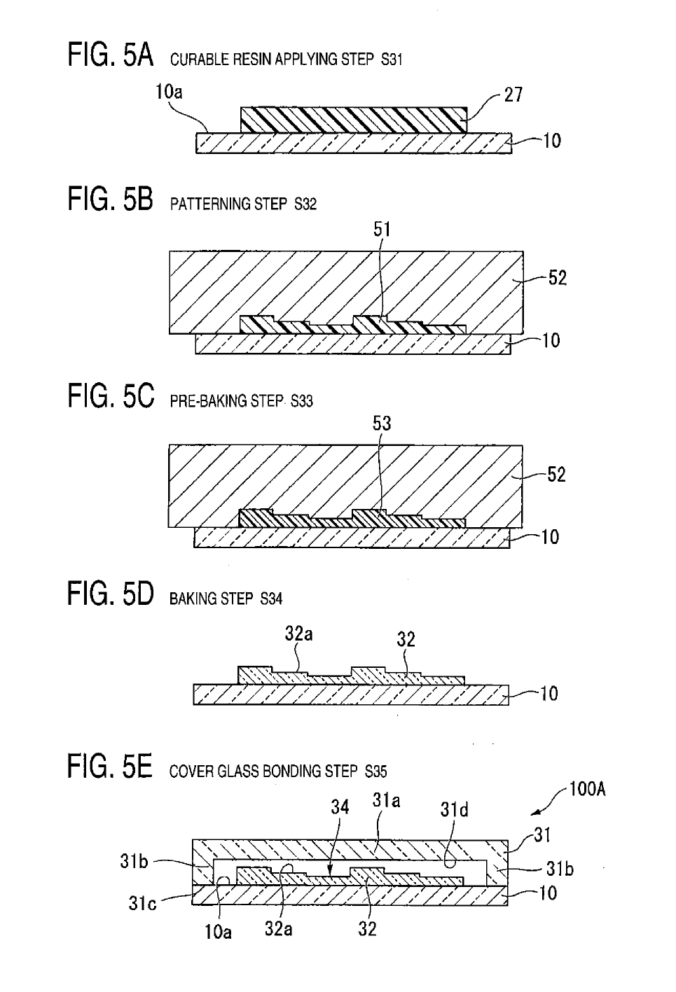

FIGS. 5A to 5E are cross-sectional views showing the method for manufacturing the optical element 100A of the embodiment.

As shown in FIGS. 5A to 5E, the method for manufacturing the optical element 100A of the embodiment includes a curable resin applying step S31, a patterning step S32, a pre-baking step S33, a baking step S34, and a cover glass bonding step S35.

As shown in FIG. 5A, the curable resin applying step S31 is the same as the curable resin applying step S11 of the first embodiment. Through this step, the resin layer 27 is formed.

Next, as shown in FIG. 5B, the patterning step S32 is a step of patterning the resin layer 27 using a mold 52.

The mold 52 is a master mold in which the concave-convex shape obtained by inverting the shape of the surface 32a of the diffractive element 32 shown in FIG. 5D is formed on a processing surface. On the processing surface of the mold 52, a release agent is applied for purposes of the prevention of adhesion of an uncured resin and an improvement in the releasability of the mold 52 from the base 10.

As shown in FIG. 5B, by pressing the mold 52 against the resin layer 27, the shape of the diffractive element 32 is transferred to the surface of the resin layer 27. The pressing method is not particularly limited, and for example, a direct pressing method, a roller transfer method, a roll-to-roll method, or the like can be selected. Through this step, the resin layer 27 is subjected to stamping processing, so that an uncured diffractive element 51 (diffractive element made of an uncured resin material) is formed. On a surface of the uncured diffractive element 51, a plurality of concave-convex portions different in height is arrayed in a planar manner.

Next, as shown in FIG. 5C, the pre-baking step S33 is the same as the pre-baking step S13 of the first embodiment. Through this step, the uncured diffractive element 51 is brought into the pre-baked state (a diffractive element 53 in the pre-baked state) in which a solvent is removed from the uncured diffractive element 51.

Next, as shown in FIG. 5D, the baking step S34 is a step of baking the diffractive element 53 in the pre-baked state.

The mold 52 is removed, and the diffractive element 53 in the pre-baked state is baked. Through this step, the diffractive element 53 in the pre-baked state is cured to form the diffractive element 32.

Next, as shown in FIG. 5E, the cover glass bonding step S35 is a step of bonding the cover glass 31 to the top surface 10a of the base 10.

The cover glass bonding step S35 is performed under an inert gas atmosphere. The inert gas is not particularly limited, and for example, nitrogen can be used.

The back surface 31c of the spacer portion 31b of the cover glass 31 is bonded to the outer edge portion of the top surface 10a of the base 10.

The bonding method of the cover glass 31 is not particularly limited, and for example, a pressure bonding method in which a bonding surface is bonded by applying a pressure from a top surface of the cover glass 31 or a method using an adhesive can be selected.

Through the step described above, the void 34 surrounded and hermetically sealed by the base 10, the cover glass 31, and the diffractive element 32 is formed. The inert gas of the atmosphere when bonding the base 10 and the spacer portion 31b together is enclosed in the void 34.

Through the steps described above, it is possible to manufacture the optical element 100A in which the diffractive element 32 is surrounded and sealed by the base 10 and the cover glass 31.

When dust or dirt adheres to the outer surface of the cover portion 31a of the cover glass 31, the dust or dirt generates heat upon irradiation of a laser beam, and the temperature of the cover portion 31a becomes high.

In this case, the heat of the cover portion 31a is conducted to the base 10 or the diffractive element 51 via the spacer portion 31b. According to the optical element 100A of the embodiment, however, since the second void portion 34b is present between the spacer portion 31b and the diffractive element 51, it is possible to suppress the conduction of heat of the cover portion 31a to the diffractive element 32 via the spacer portion 31b. With this configuration, a degradation of the diffractive element 32 can be suppressed, so that the optical element excellent in reliability is obtained.

According to the method for manufacturing the optical element 100A of the embodiment, the spacer portion 31b is a portion of the cover glass 31, and the back surface 31c of the spacer portion 31b is bonded to the top surface 10a of the base 10 to place the cover glass 31 on the base 10. The material of the cover glass 31 and the base 10 to be bonded together is glass or quartz, which has high strength. Therefore, it is possible to use a bonding method in which a large force is applied to a bonding surface (for example, a pressure bonding method in which the bonding surface is bonded by applying a pressure).

The cover glass bonding step S35 may be performed before the baking step S34.

### Fourth Embodiment

### Optical Element

An optical element of a fourth embodiment differs from the first embodiment in that a communication hole is formed in a spacer portion. The same constituents as those of the above embodiments are appropriately denoted by the same reference numerals and signs as those of the above embodiments, and the description thereof is simplified or omitted.

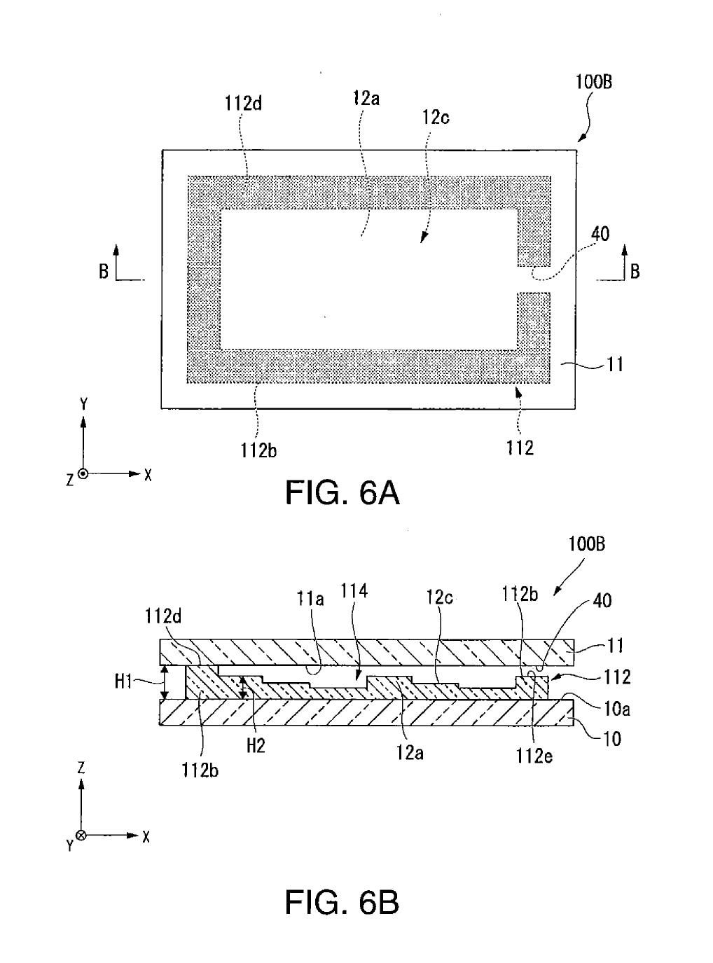

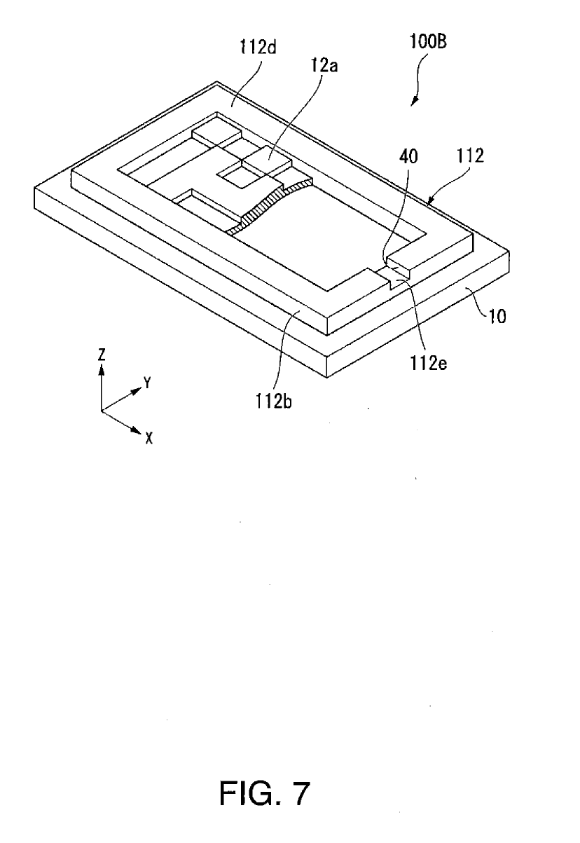

FIGS. 6A to 7 show the optical element 100B of the embodiment. FIG. 6A is a plan view. FIG. 6B is a cross-sectional view taken along line B-B in FIG. 6A. FIG. 7 is a perspective view. In FIG. 7, the cover glass 11 and a portion of the diffractive element portion 12a are not illustrated.

In the description of the embodiment, an XYZ-coordinate system is set, and with reference to the XYZ-coordinate system, the positional relation between members will be described. In this case, a thickness direction of the optical element 100B (refer to FIG. 7) is defined as a Z-axis direction, a width direction of the optical element 100B is defined as a Y-axis direction, and a length direction of the optical element 100B is defined as an X-axis direction.

As shown in FIGS. 6A and 6B, the optical element 100B of the embodiment includes the base 10, a diffractive member 112, and the cover glass 11.

The diffractive member 112 includes the diffractive element portion 12a and a spacer portion (spacer) 112b.

In a top surface 112d of the spacer portion 112b, a recessed portion (cut-out portion) 112e is formed as shown in FIGS. 6B and 7. The recessed portion 112e is a portion obtained by removing a portion of the spacer portion 112b in the thickness direction (Z-axis direction). The recessed portion 112e communicates with both a void 114 formed inside the spacer portion 112b and the outside of the spacer portion 112b, that is, an outer space.

The plan-view shape (XY-plane view) of the recessed portion 112e viewed from the Z-axis direction is not particularly limited and may be, for example, arc-shaped or trapezoidal. In the embodiment, the plan-view shape of the recessed portion 112e is, for example, rectangular as shown in FIG. 6A.

The side-view (YZ-plane view or ZX-plane view) shape of the recessed portion 112e is not particularly limited and may be, for example, semi-circular or trapezoidal. In the embodiment, the side-view shape of the recessed portion 112e is, for example, rectangular as shown in FIGS. 6B and 7.

As shown in FIG. 6B, the inner wall of the recessed portion 112e and the back surface 11a of the cover glass 11 form a communication hole 40 that makes the void 114 communicate with the outer space.

In the embodiment, since the void 114 is in communication with the outer space through the communication hole 40, an atmosphere in the void 114 is the same as an atmosphere of the outer space. That is, in the embodiment, the atmosphere in the void 114 is, for example, the air.

In the specification, the “outer space” means a space outside the optical element 100B.

Moreover, in the specification, “the void 114 is ‘in communication with’ the outer space” means that the void 114 and the outer space are linked to each other so that at least portion of the atmosphere of the outer space, that is, the air in the embodiment, can freely pass between the void 114 and the outer space.

### Method for Manufacturing Optical Element

A method for manufacturing the optical element 100B of the embodiment differs from the first embodiment in that the shape of the recessed portion 112e is transferred to a resin layer in a patterning step.

The method for manufacturing the optical element 100B of the embodiment includes a curable resin applying step, a patterning step, a pre-baking step, a baking step, and a cover glass bonding step.

First, the curable resin applying step is the same as the curable resin applying step S11 of the first embodiment (refer to FIG. 2A).

Through this step, the resin layer is formed.

Next, the patterning step is a step of patterning the resin layer using a mold.

The mold used in the embodiment differs from the mold 26 of the first embodiment in that a convex portion obtained by inverting the shape of the recessed portion 112e in the spacer portion 112b is formed.

The mold is pressed against the resin layer to transfer the shapes of the diffractive element portion 12a and the spacer portion 112b to a surface of the resin layer.

Through this step, the resin layer is subjected to stamping processing, so that an uncured diffractive member is formed. The uncured diffractive member is formed with an uncured diffractive element portion and an uncured spacer portion formed with the recessed portion 112e.

Next, the pre-baking step is the same as the pre-baking step S13 of the first embodiment (refer to FIG. 2C).

Through this step, the uncured diffractive member is brought into the pre-baked state in which a solvent is removed from the uncured diffractive member.

Next, the baking step is the same as the baking step S14 of the first embodiment (refer to FIG. 2D).

Through this step, the diffractive member in the pre-baked state is cured to form the diffractive member 112. Moreover, the diffractive element portion in the pre-baked state and the spacer portion in the pre-baked state are cured to thereby form the diffractive element portion 12a and the spacer portion 112b.

Next, the cover glass bonding step is a step of bonding the back surface 11a of the cover glass 11 to the top surface 112d of the spacer portion 112b.

The bonding method of the cover glass 11 is the same as the cover glass bonding step S15 of the first embodiment. In the cover glass bonding step of the embodiment, the bonding of the cover glass 11 may not be performed under an inert gas atmosphere, which is different from the cover glass bonding step S15 of the first embodiment. This is because since the recessed portion 112e is formed in the spacer portion 112b in the embodiment, the atmosphere in the void 114 to be formed is the same as the atmosphere of the outer space.

Through this step, the void 114 surrounded by the diffractive element portion 12a, the spacer portion 112b, and the cover glass 11 is formed between the back surface 11a of the cover glass 11 and the surface 12c of the diffractive element portion 12a. Moreover, the back surface 11a of the cover glass 11 and the recessed portion 112e of the spacer portion 112b form the communication hole 40 that makes the void 114 communicate with the outer space.

Through the steps described above, it is possible to manufacture the optical element 100B in which the diffractive element portion 12a is surrounded by the base 10, the cover glass 11, and the spacer portion 112b.

When a gas is hermetically sealed in the void surrounded by the diffractive element portion, the spacer portion, and the cover glass, the gas in the void thermally expands due to the irradiation of light or the like, leading to a risk of damage of the optical element.

In contrast, according to the embodiment, since the void 114 is in communication with the outer space through the communication hole 40, the void 114 is not hermetically sealed. With this configuration, even when the gas in the void 114 thermally expands, the damage of the optical element 100B can be suppressed.

Moreover, according to the embodiment, the resin layer can be patterned into the shapes of the diffractive element portion 12a and the spacer portion 112b formed with the recessed portion 112e at one time in the patterning step. Therefore, according to the embodiment, the labor of separately forming the recessed portion 112e is saved, so that the method is simple.

In the embodiment, the following configurations and manufacturing method can also be adopted.

In the embodiment, the shape of the communication hole 40 is not particularly limited as long as the communication hole 40 makes the void 114 communicate with the outer space. In the embodiment, the communication hole 40 may be formed of, for example, a through-hole penetrating through the spacer portion 112b in the width direction (X-axis direction). In this case, the shape of the through-hole is not particularly limited and may be a quadratic prism, columnar, or tapered.

Moreover, in the embodiment, a cut-out portion obtained by removing a portion of the spacer portion 112b in the entire thickness direction (Z-axis direction) may be formed instead of the recessed portion 112e of the spacer portion 112b. In this case, the communication hole 40 is formed by the back surface 11a of the cover glass 11, the top surface 10a of the base 10, and the cut-out portion.

Moreover, the embodiment described above is configured such that only one communication hole 40 is formed in the spacer portion 112b. However, the embodiment is not limited to this. The embodiment may be configured such that two or more communication holes 40 are formed in the spacer portion 112b.

Moreover, the embodiment may be configured such that, for example, a porous member capable of making the void 114 communicate with the outer space is disposed in the communication hole 40. According to the configuration, dust can be prevented from entering the interior of the void 114 from the outer space.

Moreover, the embodiment described above adopts the manufacturing method in which the spacer portion 112b formed with the recessed portion 112e is formed in the patterning step. However, the embodiment is not limited to this. In the embodiment, for example, a spacer portion not formed with the recessed portion 112e may be formed in the patterning step, and thereafter, a step of forming the recessed portion 112e may be performed as a separate step.

### Embodiment of Projector

This embodiment is a projector in which the optical element 100 of the first embodiment is used as an element that diffuses light emitted from a laser light source.

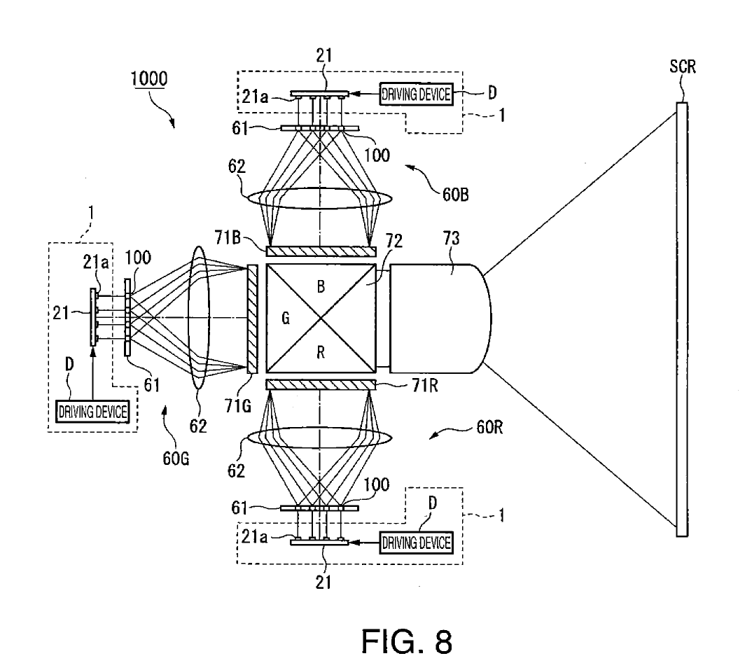

FIG. 8 is a schematic view showing the projector 1000 of the embodiment.

As shown in FIG. 8, the projector 1000 of the embodiment includes an illumination device 60R, an illumination device 60G, an illumination device 60B, a liquid crystal light modulator (light modulator) 71R, a liquid crystal light modulator 71G, a liquid crystal light modulator 71B, a color combining system 72, and a projection optical system 73. The projector 1000 projects image light in accordance with externally input image signals onto a screen SCR to thereby display an image on the screen SCR.

Each of the illumination devices 60R, 60G, and 60B includes a light source device 1, a diffractive optical system 61, and an angle adjusting optical element 62. The illumination devices 60R, 60G, and 60B respectively emit red light, green light, and blue light to the liquid crystal light modulators 71R, 71G, and 71B. The light source device 1 disposed in the illumination device 60R emits red light. The light source device 1 disposed in the illumination device 60G emits green light. The light source device 1 disposed in the illumination device 60B emits blue light. Since the illumination devices 60R, 60G, and 60B have the same configuration excepting that the colors of light emitted therefrom are different from one another, the illumination device 60B will be described below.

The light source device 1 includes a solid-state light source array 21 and a driving device D.

The solid-state light source array 21 includes a plurality of solid-state light sources 21a arrayed in a planar manner (in a matrix) on a substantially rectangular substrate.

The solid-state light source 21a is a semiconductor laser that emits blue light (peak light emission intensity: about 460 nm). The solid-state light source 21a is driven by the driving device D. The solid-state light source 21a included in the illumination device 60R is a semiconductor laser that emits red light, while the solid-state light source 21a included in the illumination device 60G is a semiconductor laser that emits green light.

The diffractive optical system 61 includes a plurality of optical elements 100 respectively corresponding to the plurality of solid-state light sources 21a disposed in the solid-state light source array 21. The diffractive optical system 61 diffracts the blue light emitted from the solid-state light source 21a at a predetermined angle. Specifically, for example, when the solid-state light source array 21 includes a total of 16 solid-state light sources 21a, the diffractive optical system 61 includes a total of 16 optical elements 100 arrayed in a matrix of four rows and four columns. However, the number of optical elements 100 is not limited to this. A configuration may be adopted in which the blue lights emitted from the respective solid-state light sources 21a are incident on one optical element 100.

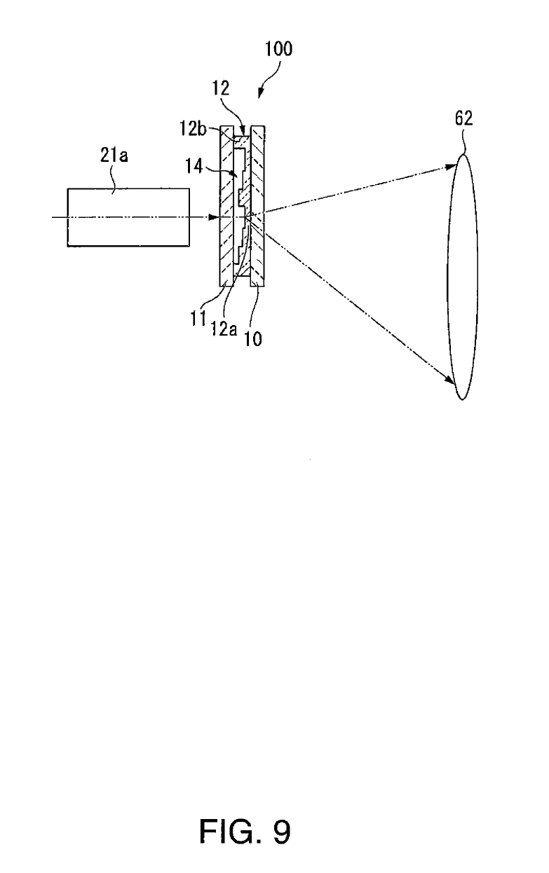

FIG. 9 is an explanatory view showing the arrangement of the optical element 100 in the embodiment.

As shown in FIG. 9, each of the optical elements 100 is arranged such that the cover glass 11 is located on the side of the solid-state light source 21a while the base 10 is located on the side of the angle adjusting optical element 62. That is, blue light is incident on the optical element 100 from the cover glass 11 side.

The blue light incident on the optical element 100 is incident on the diffractive element portion 12a via the void 14. Then, the blue light is diffused by the diffractive element portion 12a, emitted from the base 10, and incident on the angle adjusting optical element 62.

As shown in FIG. 8, the angle adjusting optical element 62 is composed of a refractive lens (field lens) and disposed for adjusting the angle of the blue light diffracted by the diffractive optical system 61 to introduce the blue light to the liquid crystal light modulator 71B. In the embodiment, the angle adjusting optical element 62 is, optimized such that an irradiated surface of the liquid crystal light modulator 71B is illuminated in a superimposed manner by diffracted lights diffracted by the plurality of optical elements 100.

By disposing the angle adjusting optical element 62, the incident angle of blue light with respect to the liquid crystal light modulator 71B can be made small. Also, the incident angle of blue light with respect to the liquid crystal light modulator 71B can be equalized in a plane thereof. Therefore, the liquid crystal light modulator 71B can be efficiently illuminated. In addition, since the liquid crystal light modulator 71B is illuminated in a superimposed manner by the plurality of diffracted lights emitted from the diffractive optical system 61, the liquid crystal light modulator 71B can be efficiently illuminated with high illuminance. Moreover, the occurrence of a speckle pattern is suppressed, so that the liquid crystal light modulator 71B can be illuminated with a substantially uniform illuminance distribution.

The liquid crystal light modulators 71R, 71G, and 718 modulate, according to externally input image signals, color lights incident thereon to generate red image light, green image light, and blue image light, respectively. The red light from the illumination device 60R is incident on the liquid crystal light modulator 71R. The green light from the illumination device 60G is incident on the liquid crystal light modulator 71G. The blue light from the illumination device 60B is incident on the liquid crystal light modulator 71B. The color combining system 72 combines the image lights generated by the respective liquid crystal light modulators 71R, 71G, and 71B. The projection optical system 73 enlarges the modulated light combined by the color combining system 72 and projects the modulated light onto the screen SCR.

According to the projector 1000 of the embodiment, a laser beam emitted from the solid-state light source 21a is diffused by the diffractive element portion 12a of the optical element 100. The diffractive element portion 12a is surrounded and sealed by the base 10, the cover glass 11, and the spacer portion 12b. With this configuration, dust or dirt does not directly adhere to the diffractive element portion 12a. Hence, heat generated due to the dust or dirt being irradiated with the laser beam is not directly conducted to the diffractive element portion 12a. Therefore, even when the intensity of the laser beam with which the diffractive element portion 12a is irradiated is high, the breakage of the diffractive element portion 12a due to heat can be suppressed. Therefore, according to the embodiment, a degradation of the diffractive element portion can be suppressed, so that the projector excellent in reliability is obtained.

Moreover, the laser beam emitted from the solid-state light source 21a is incident on the optical element 100 from the side of the cover glass 11. The laser beam incident on the optical element 100 is incident on the diffractive element portion 12a via the void 14. Then, light diffused by the diffractive element portion 12a passes through the base 10 to be emitted to the outside. Since the light incident on the cover glass 11 is a laser beam, the intensity of the light is high. Therefore, when dust or dirt adheres to the light incident side (inside the optical axis) of the cover glass 11, the dust or dirt generates heat, and the temperature of the cover glass 11 is likely to become high. Therefore, in the projector of the embodiment, the void 14 is disposed between the cover glass 11 and the diffractive element portion 12a. With this configuration, the heat of the cover glass 11 is less likely to be conducted to the diffractive element portion 12a.

Moreover, since the light emitted from the base 10 is diffused by the diffractive element portion 12a, the intensity of the light emitted from the base 10 is low. Therefore, even when dust or dirt adheres to the light emitting side (outside the optical axis) of the base 10, the amount of heat generated due to the irradiation of the dust or dirt with light is small, and the possibility of a degradation of the diffractive element is low.

Although, in the embodiment, the optical element 100 of the first embodiment is used as an optical element, the optical element of the second embodiment, the third embodiment, or the fourth embodiment may be used.

The entire disclosure of Japanese Patent Application No.: 2013-045719, filed on Mar. 7, 2013 and 2013-252326, filed on Dec. 5, 2013 are expressly incorporated by reference herein.

What is claimed is:

1. An optical element comprising:
a first glass substrate;
a second glass substrate;
a diffractive element disposed on the first glass substrate and made of a resin;
a spacer disposed between the first glass substrate and the second glass substrate and regulating a gap between the first glass substrate and the second glass substrate; and
a first void disposed between the second glass substrate and the diffractive element.

2. The optical element according to claim 1, wherein
the first void is hermetically sealed.

3. The optical element according to claim 1, wherein
a communication hole is formed in the spacer such that the first void communicates with an outer space.

4. The optical element according to claim 1, wherein
the spacer and the diffractive element are integrated with each other.

5. The optical element according to claim 1, wherein
a second void is disposed between the spacer and the diffractive element.

6. A method for manufacturing an optical element, comprising:
applying a resin on a first glass substrate to form a resin layer;
pressing a mold against the resin layer to pattern the resin layer, thereby forming a diffractive element and a spacer having a thickness larger than that of the diffractive element;
curing the resin layer; and
placing a second glass substrate on the spacer.

7. The method for manufacturing an optical element according to claim 6, wherein
after patterning the resin layer, the second glass substrate is placed on the spacer that is uncured, and then, the resin layer is cured.

8. The method for manufacturing an optical element according to claim 6, wherein
in the forming of the spacer, a cut-out portion is formed in the spacer, and
the cut-out portion constitutes a communication hole that makes a first void disposed between the second glass substrate and the diffractive element communicate with an outer space.

9. A projector comprising the optical element according to claim 1.

10. A projector comprising the optical element according to claim 2.

11. A projector comprising the optical element according to claim 3.

12. A projector comprising the optical element according to claim 4.

13. A projector comprising the optical element according to claim 5.

14. The projector according to claim 9, further comprising:
a solid-state light source irradiating the optical element with light; and
a light modulator modulating light emitted from the optical element, wherein
the light from the solid-state light source is incident on the diffractive element from the second glass substrate side.

15. The projector according to claim 10, further comprising:
a solid-state light source irradiating the optical element with light; and
a light modulator modulating light emitted from the optical element, wherein
the light from the solid-state light source is incident on the diffractive element from the second glass substrate side.

16. The projector according to claim 11, further comprising:
a solid-state light source irradiating the optical element with light; and
a light modulator modulating light emitted from the optical element, wherein
the light from the solid-state light source is incident on the diffractive element from the second glass substrate side.

17. The projector according to claim 12, further comprising:
a solid-state light source irradiating the optical element with light; and
a light modulator modulating light emitted from the optical element, wherein
the light from the solid-state light source is incident on the diffractive element from the second glass substrate side.

18. The projector according to claim 13, further comprising:
a solid-state light source irradiating the optical element with light; and
a light modulator modulating light emitted from the optical element, wherein
the light from the solid-state light source is incident on the diffractive element from the second glass substrate side.
